(19) United States
(12) Patent Application Publication
(10) Pub. No.: US 2002/0109623 A1
(43) Pub. Date: Aug. 15, 2002

(54) Weather radar monopole

(76) Inventor: Barney Timon Ware, Boynton Beach, FL (US)

Correspondence Address: Storm Radar, LLC, Ste. 414, 520 Santa Rosa Blvd., Fort Walton Beach, FL, 32548, US

(21) Appl. No.: 09/781,493

(22) Filed: Feb. 13, 2001

(51) Int. Cl. G01S 13/95

(52) U.S. Cl. 342/26

(57) ABSTRACT

Previous attempts to persuade reluctant landowners to allow a tower on their property have been limited to attempts to disguise or enhance the appearance of the tower. The Invention actually provides a service to the owner, continuous weather radar coverage, the desirability of which persuades owners to allow a tower to be placed on their property. Generally, the provision of a service to a landowner, independent of the wireless capabilities of the tower site, is the novelty of the Invention. Specifically, the combination of weather radar with a tower which houses wireless antennas is the Invention, which is new to the art of wireless antenna siting.

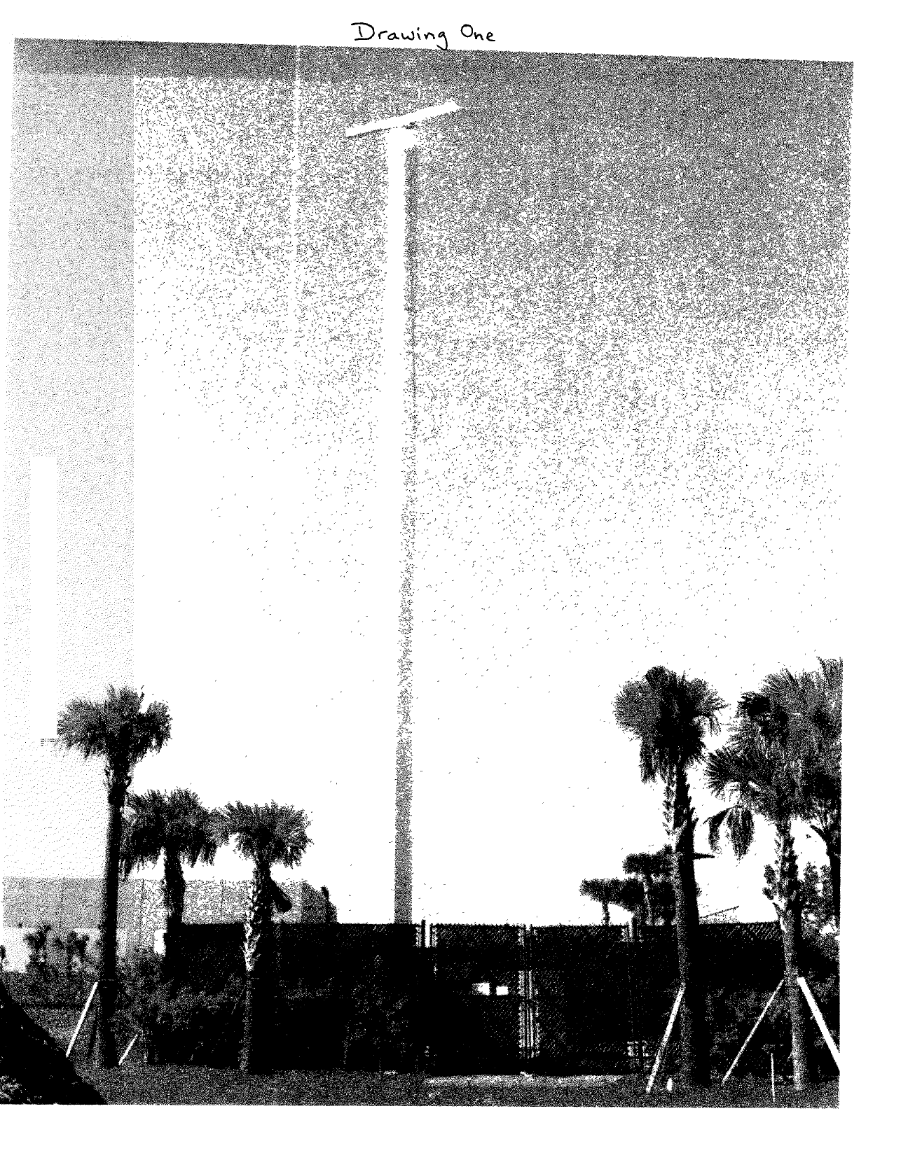

### BACKGROUND

A key component of the booming cellular/PCS/wireless industry is the ability to construct the required infrastructure to make a wireless system work. Each carrier selling a wireless product must bring that product to market by building their own system of infrastructure (this does not include those who merely re-sell another company's wireless product). That infrastructure consists of, among other things, antenna sites (mounting locations for a carrier's antennas to broadcast and receive signals from their customers' wireless devices). These sites are primarily located on free-standing towers erected for this purpose. As a result of the multiple license-holders present in any given market, each of which represents a potential tenant on a tower structure, ownership of antenna towers has largely become vested in dedicated tower companies. The tower companies acquire rights to property, permit and construct a tower, then rent space on the tower to the wireless carriers for the placement of their antennas. A single tower can provide locations for a number of potential carriers.

Because of zoning constraints and the demands of discerning landlords or community groups, those in the industry have devised several alternative-type structures to appease design concerns. This is especially true in residential, high-end or water-front areas where tall structures tend to stand-out more significantly and esoteric concerns (usually related to fear of deflated property values) create greater opposition to prospective sites. Among the creative solutions invented thus far are sites disguised as bell towers or clock towers, artificial pine/palm trees and flagpoles, each of which can hide the antennas of one or more carrier. It is against this background that the applicant, Storm Radar, LLC, has developed a new form of alternative structure designed specifically for high-end, residential and difficult to zone areas. The Invention also differs from previous efforts as it serves a valuable function not only to the carriers, but also the prospective landlords where the Invention will be located.

### SUMMARY OF THE INVENTION

The Invention, referred to herein as the “Weather Radar Monopole”, is comprised of the combination of existing monopole technology with a weather radar unit. The weather radar unit provides the landlord with location-oriented weather forecasts for use by its staff, customers, clients, invitees, etc. The Weather Radar Monopole utilizes monopole tower technology and marine radar technology, usually combined with computer technology (allowing us to uplink the information from the radar to the internet). The novelties of this Invention stem from: (1) the use of a service provided to the landlord at a prospective site to induce them into allowing a communications tower to be erected on their property; and (2) the particular combination of technologies from different industries. Previously, attempts were only made to conceal or minimize the non-appealing visual aspects of a tower in order to assist efforts to find a willing landlord or persuade a reluctant zoning board or community group. We have combined technologies in use in other industries with tower technologies in use in the wireless industry. Just as the creation of a monopole with fiberglass bark, limbs and foliage was a novel means of addressing siting difficulties, Applicant's invention will open-up even further doors in heretofore impossible to obtain areas.

### DESCRIPTION OF PROVIDED DRAWING

Drawing One shows an elevation view of a typical Weather Radar Monopole. At the top of the Drawing, the rotating weather radar transceiver is visible. The Monopole itself conceals the power and signal cables for the radar and the antennas and lines for any carriers inside. At the base of the monopole lies one or more equipment shelter(s), which house(s) the ground-based equipment for the radar and any carriers operating on the Monopole. The rotating antenna radiator receives the reflected radar energy and transmits it, via cables, run from the antenna radiator through the inside of the Monopole down to a processor unit, control unit and video source, located near the base of the Monopole. The signal from the processor/control units will then be sent to a local video monitor (e.g., a television inside the clubhouse of a Country Club) or, via a web server, uploaded through an ethernet connection to an Internet Service Provider provided router and, eventually, to the global internet, where Applicant will maintain a web site from which the general public can view current weather conditions at the prospective site from a remote location.

### DETAILED DESCRIPTION OF THE WEATHER RADAR MONOPOLE

A Weather Radar Monopole consists of a radar antenna unit located at or near the top of a Monopole. The radar antenna unit is comprised of a rotating antenna radiator/transceiver located on a mounting unit and affixed to the monopole. The tower and radar shall be grounded through the use of graphite or other frequency transparent material(s) located at the top of the tower. The Monopole itself shall be of a type of construction, which minimizes the visual obtrusiveness of antennas mounted to its sides. Typical monopoles are of galvanized steel construction, assembled in sections, and will generally be painted to suit a prospective landlord (usually green or brown to blend into adjoining foliage). On a conventional monopole, mounting platforms—usually three-sided and resembling crow's nests—are affixed to the pole at each height where a carrier desires to mount its antennas. Then, antenna mounts are attached to the mounting platform, in various configurations, and actual antennas, which are typically long panels (e.g., a four foot high by one foot wide by four inch deep panel) are affixed to those mounts. A typical site will have one to five antennas per side of a three-sided mounting platform (a total of 3-15 antennas), per carrier. The proposed Monopole will utilize flush-mounted antennas (antennas mounted directly to the sides of the Monopole) or antennas that are actually built into the Monopole's structure and hidden by frequency-transparent outer shrouds (these antennas are not readily apparent to the naked eye, as the lines of the Monopole remain clean, straight lines). As can be seen on the attached Drawing One, antennas can be mounted beneath the exterior surface of the monopole, rendering them invisible to observers (the antennas are located inside the top section of the monopole just below the radar transceiver mounted on the top). The only current monopoles constructed to conceal the antennas inside the pole are sites with an ornamental structure or one or more flags hanging from the top. In Applicant's novel configuration, there will be a weather radar unit at the top rather than such an ornamental, non-functional appliance. Lower sections of the Monopole are used merely to elevate the radar antennas and prospective carriers' antennas (usually, above tree-line) to a height capable of accomplishing the coverage objectives for the site.

The proposed Monopole shall be capable of accepting the antennas for at least one carrier. At the base of the Monopole, one or more equipment cabinet(s), shelter(s) or other housing(s) will be present to hold the electronics for the weather radar, web servers (if applicable) and equipment for any carriers present. Additionally, there may be cable runs from the weather radar base station equipment to a remote video monitor located somewhere on the property for the use of landlord and its customers/guests/etc. Electrical and telephone connections will be made in the equipment housings from utilities drawn from the nearest public right of way or other utility right of way.

Applicant combines a “black-box” weather radar unit (normally used aboard marine crafts) with a low-profile monopole tower. The weather radar picture from the unit is provided to the landlord at an on-site terminal or via the worldwide web/internet. At sites, such as Country Clubs, marinas and municipal golf courses, accurate, local weather forecasts offer enhanced safety and convenience. Applicant has created the Invention in order to market this valuable service to landlords as a means to attain otherwise unattainable tower locations for the provision of wireless services.

What we claim as our inventions are:

1) the provision of weather radar to a prospective landlord in order to obtain the right to site an antenna tower; and

2) the combination of a weather radar unit with a terrestrial tower designed to also accommodate wireless antennas.
